(19) United States
(12) Patent Application Publication
(10) Pub. No.: US 2006/0267893 A1
(43) Pub. Date: Nov. 30, 2006

(54) Methods, circuits and displays for selectively compensating for gray-scale

(75) Inventors: Do-Kyung Kim, Yongin-si (KR); Hyun-Young Park, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/377,535

(22) Filed: Mar. 16, 2006

(30) Foreign Application Priority Data
May 30, 2005 (KR) 10-2005-0045626

(51) Int. Cl. G09G 3/36

(52) U.S. Cl. 345/89

(57) ABSTRACT

Gray-scale values of a display are compensated for by selectively providing a gray-scale value of a current frame of the display or a compensated gray-scale value of the current frame of the display, in response to a difference between the gray-scale value of the current frame of the display and a gray-scale value of a preceding value of the display, relative to a reference value. The compensated gray-scale value may be determined by interpolating values in a lookup table. Associated circuits and liquid crystal displays according to the above-described embodiments are also provided.

### CROSS-REFERENCE TO RELATED PATENT APPLICATION

This application claims the benefit under 35 USC §119 of Korean Patent Application No.10-2005-0045626, filed on May 30, 2005, the disclosure of which is hereby incorporated herein by reference in its entirety as if set forth fully herein.

### FIELD OF THE INVENTION

The present invention relates to displays, such as liquid crystal displays (hereinafter referred to as “LCD”), and more particularly, to gray-scale compensating methods and circuits that can increase the response speed of displays, such as portable small and medium sized LCDs, and display devices having the circuits.

### BACKGROUND OF THE INVENTION

As personal computers, televisions and other devices become slimmer and lighter, display devices have also become slimmer and lighter. To keep pace with this trend, flat panel type displays, such as an LCD, are being used.

An LCD is a display device on which a desired image signal is formed by applying an electric field to a liquid crystal material. Among the LCDs, thin film transistor (TFT)-LCDs that use a TFT as a switching device have been widely used.

As is well known, an LCD may have a slow response speed, which may render an LCD less desirable for displaying moving pictures. The dynamic capacitance compensation (DCC) technology has been used to improve the response speeds of the LCDs.

In the DCC technology, the response speed of an LCD panel is compensated for by comparing a gray-scale value (‘gray signal’ or ‘gray voltage’) of a previous frame with that of a current frame, and over-driving or under-driving gray-scale values, based on a look-up table (LUT). The LUT can list compensated gray-scale values for every possible case of the previous and current frames. In general, the compensated gray-scale values are experimentally measured, and the size of the LUT may significantly affect the chip size and complexity of a liquid crystal driving device. That is, when all of compensated gray-scale values for every possible case is stored in the LUT, the size of the LUT may increase, which may increase the size and complexity of the liquid crystal driving device.

An algorithm that allows calculation of LUT values for every possible case by using interpolation has been introduced. This algorithm can decrease the size of the LUT. However, the size of the LUT that is designed for large-scale LCDs may still be too large to be applied to portable small and medium sized LCDs. Also, in the case where an abbreviated LUT obtained by reducing the size of the original LUT is used, image quality may be degraded when gray-scale values of a particular region (a diagonal region, etc.) of the abbreviated LUT are interpolated by a conventional interpolation method.

### SUMMARY OF THE INVENTION

Gray-scale values of a display are compensated for, according to some embodiments of the present invention, by selectively providing a gray-scale value of a current frame of the display or a compensated gray-scale value of the current frame of the display, in response to a difference between the gray-scale value of the current frame of the display and a gray-scale value of a preceding value of the display, relative to a reference value. In some embodiments, the compensated gray-scale value of the current frame is provided if the difference between the gray-scale value of the current frame and the gray-scale value of the preceding frame exceeds the reference value. Moreover, the gray-scale value of the current frame is provided if the difference between the gray-scale value of the current frame and the gray-scale value of the preceding frame is less than the reference value. In some embodiments, the compensated gray-scale value may be determined by interpolating values in a lookup table. The gray-scale value or the compensated gray-scale value that is selectively provided may then be applied to the display, such as a liquid crystal display. Associated circuits and liquid crystal displays according to the above-described embodiments also may be provided.

According to some embodiments of the present invention, there is provided a method of compensating for gray-scale values of a liquid crystal display, the method including setting a reference value; comparing a difference between a gray-scale value of a current frame and a gray-scale value of a previous frame with the reference value; and outputting the gray-scale value of the current frame or a compensated gray-scale value according to the comparison result.

The compensated gray-scale value may be generated based on data regarding at least one of a plurality of measured gray-scale values, where data regarding the measured gray-scale values is stored in a data storage circuit. During the setting of the reference value, the reference value may be set to one of 0 to 7.

During the outputting of one of the gray-scale value of the current frame or the compensated gray-scale value, the compensated gray-scale value may be output when the difference is greater than the reference value, and the gray-scale value of the current frame may be output otherwise.

According to other embodiments of the present invention, there is provided a circuit for compensating for gray-scale values. The circuit includes a selection signal generation circuit configured to receive a gray-scale value of a current frame and a gray-scale value of a previous frame, to compute the difference between the received gray-scale values, and to generate a selection signal indicating a result of comparing the difference with a reference value. A gray-scale value selection circuit is configured to output the gray-scale value of the current frame or a compensated gray-scale value in response to the selection signal.

In some embodiments, the selection signal generation circuit comprises a register configured to store the reference value; an operation unit configured to receive the gray-scale values of the current and previous frames, to compute the difference between the received gray-scale values, and to output the computed difference; and a comparator configured to receive the reference value from the register and the difference from the operation unit, to compare the reference value with the difference, and to output the selection signal indicating the comparison result.

In some embodiments, the gray-scale value selection circuit comprises a data storage circuit configured to store data regarding a plurality of measured gray-scale values, to receive the gray-scale values of the current and previous frames, and to output the data regarding at least one of the measured gray-scale values based on the gray-scale values of the current and previous frames. An operation unit is configured to perform an operation on the data regarding the at least one gray-scale value output from the data storage circuit, and to output the compensated gray-scale value according to the operation result. A selection circuit is configured to receive the compensated gray-scale value from the operation unit and the gray-scale value of the current frame, and to output the gray-scale value of the current frame or the compensated gray-scale value in response to the selection signal.

According to other embodiments of the present invention, there is provided a display device comprising a liquid crystal display panel including a plurality of pixels, a respective one of which is located at a respective intersection of a gate line and a corresponding data line. A gray-scale value compensation circuit is configured to receive a gray-scale value of a current frame and a gray-scale value of a previous frame, to compute the difference between the received gray-scale values, and to output the gray-scale value of the current frame or a compensated gray-scale value in response to a selection signal indicating a result of comparing the difference with a reference value. A data driver is configured to apply a voltage corresponding to the gray-scale value of the current frame or the compensated gray-scale value, which is received from the gray-scale value compensation circuit, to a corresponding data line of the liquid crystal display panel. A gate driver is configured to apply a gate-on signal to a corresponding gate line of the liquid crystal display panel.

According to yet other embodiments of the present invention, there is provided a method of driving data lines of a display device which includes a liquid crystal display panel including a plurality of pixels, a respective one of which is located at a respective intersection of a gate line and a corresponding data line. The method comprises receiving a gray-scale value of a current frame and a gray-scale value of a previous frame, computing the difference between the received gray-scale values, and outputting the gray-scale value of the current frame or a compensated gray-scale value according to a result of comparing the difference with a reference value. A voltage corresponding to the gray-scale value of the current frame or the compensated gray-scale value is applied to a corresponding data line of the liquid crystal display panel.

### BRIEF DESCRIPTION OF THE DRAWINGS

FIG. 1 is a block diagram illustrating a display device according to some embodiments of the present invention;

FIG. 2 is a block diagram illustrating a gray-scale value compensation circuit according to some embodiments of the present invention;

FIG. 3A is a view illustrating a conventional look-up table (LUT);

FIG. 3B is a view illustrating an LUT that includes gray-scale values according to some embodiments of the present invention;

FIG. 4A is a conceptual diagram illustrating computation of compensated gray-scale values that are not included in an LUT according to some embodiments of the present invention;

FIG. 4B is a detailed table illustrating computation of a compensated gray-scale value not included in an LUT according to some embodiments of the present invention;

FIG. 5 is a flowchart illustrating operations for compensating for gray-scale values according to some embodiments of the present invention; and

FIG. 6 is a flowchart illustrating operations for driving data lines of a display device according to some embodiments of the present invention.

### DETAILED DESCRIPTION OF THE INVENTION

The invention will be described more fully hereinafter with reference to the accompanying drawings, in which example embodiments of the invention are shown. This invention may, however, be embodied in many different forms and should not be construed as limited to the example embodiments set forth herein. Rather, the disclosed embodiments are provided so that this disclosure will be thorough and complete, and will fully convey the scope of the invention to those skilled in the art. Like numbers refer to like elements throughout.

It will be understood that when an element is referred to as being “connected to” and/or “coupled to” another element, it can be directly connected or coupled to the other element or intervening elements may be present. In contrast, when an element is referred to as being “directly connected to” and/or “directly coupled to” another element, there are no intervening elements present. As used herein, the term “and/or” includes any and all combinations of one or more of the associated listed items. Moreover, as used herein, the term “or” indicates either one or the other of the listed items, but not both of the listed items.

It will be understood that, although the terms first, second, third etc. may be used herein to describe various elements, components, regions and/or sections, these elements, components, regions and/or sections should not be limited by these terms. These terms may be used to distinguish one element, component, region and/or section from another region and/or section. For example, a first element, component, region and/or section discussed below could be termed a second element, component, region and/or section without departing from the teachings of the present invention.

The terminology used herein is for the purpose of describing particular embodiments only and is not intended to be limiting of the invention. As used herein, the singular terms “a”, “an” and “the” are intended to include the plural forms as well, unless the context clearly indicates otherwise. It will be further understood that the terms “comprises,” “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

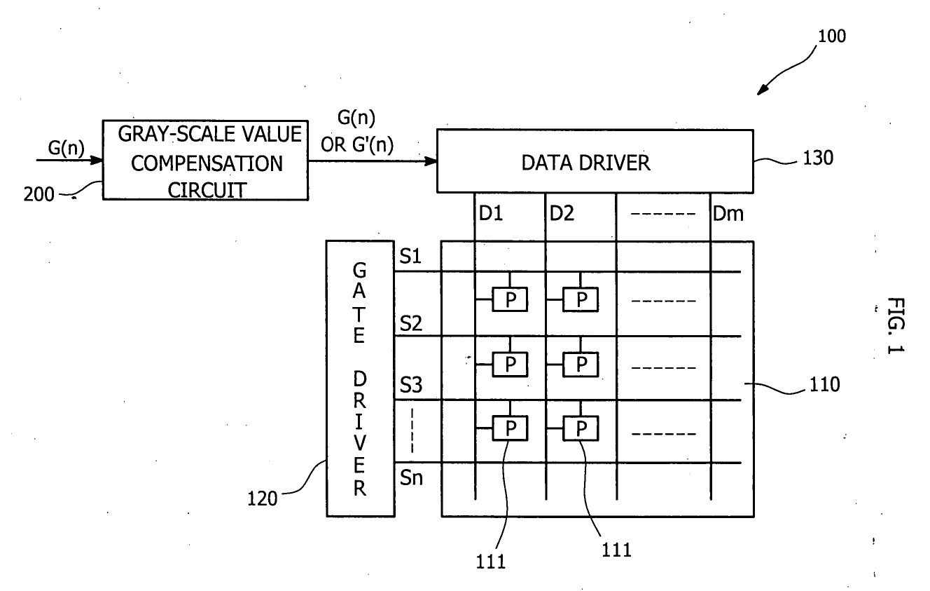

FIG. 1 is a block diagram of a display device 100 according to some embodiments of the present invention. Referring to FIG. 1, the display device 100 includes an LCD panel 110, a gate driver 120, a data driver 130, and a gray-scale value compensation circuit 200.

The LCD panel 110 includes a plurality of gate lines S1, S2, S3, . . . , Sn via which gate-on signals are transmitted, and a plurality of data lines D1, D2, . . . , Dm via which compensated gray-scale values (or voltages corresponding to the compensated gray-scale values) are transmitted.

As well known, a respective pixel (P) 111 is located at an intersection of one of the gate lines S1, S2, S3, . . . , Sn and a corresponding one of the data lines D1, D2, . . . , Dm. Each pixel 111 includes a thin film transistor (TFT) and/or other device whose gate electrode and source electrode are respectively connected to a corresponding gate line and data line, and a capacitor connected to a drain electrode of the TFT.

The gate driver 120 sequentially applies a gate-on voltage to the gate lines S1, S2, S3, . . . , Sn to turn on the TFTs whose gate electrodes are respectively connected to corresponding gate lines S1, S2, S3, . . . , Sn.

The gray-scale value compensation circuit 200 is configured to receive a gray-scale value G(n) of a current frame, to compute the difference between the gray-scale value G(n) of the current frame and a gray-scale value G(n-1) of a previous frame, and to output the gray-scale value G(n) or a compensated gray-scale value G′(n) to the data driver 130 in response to a selection signal based on a result of comparing the computed difference with a reference value. The reference value may be fixed or may vary over time.

The data driver 130 applies a voltage corresponding to the gray-scale value G(n) or G′(n) received from the gray-scale value compensation circuit 200 to a corresponding one of the data lines D1, D2, . . . , Dm of the LCD panel 110.

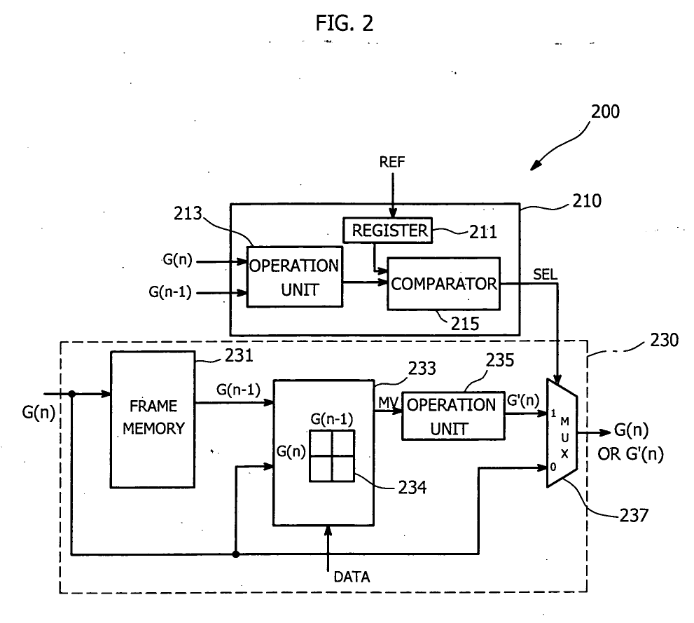

FIG. 2 is a block diagram illustrating a gray-scale value compensation circuit 200 of FIG. 1, according to some embodiments of the present invention. Referring to FIG. 2, the gray-scale value compensation circuit 200 includes a selection signal generation circuit 210 and a gray-scale value selection circuit 230.

The selection signal generation circuit 210 is configured to receive the gray-scale value G(n) of the current frame and the gray-scale value G(n-1) of the previous frame, to compute the difference between them, to compare the computed difference with the reference value REF, and to generate the selection signal SEL indicating the comparison result.

The gray-scale value selection circuit 230 is configured to output the gray-scale value G(n) of the current frame or the compensated gray-scale value G′(n) in response to the selection signal SEL.

The selection signal generation circuit 210 includes a register 211, an operation unit 213, and a comparator 215. The register 211 is configured to receive and store the reference value REF that may be received from a central processing unit (CPU), a processor and/or another device.

The operation unit 213 is configured to receive the gray-scale values G(n) and G(n-1), to compute the difference between them, and to output the difference to the comparator 215.

The comparator 215 is configured to receive the reference value REF from the register 211 and the difference from the operation unit 213, to compare them, and to output the selection signal SEL representing the comparison result.

For instance, the selection signal generation circuit 210 generates the selection signal SEL using the following:

$$SEL = \{ \frac{0 , if \vert G ( n ) - G ( n - 1 ) \vert \leq REF}{1 , otherwise} \qquad ( 1 )$$

The reference value REF may be set to one of 0 to 7 by CPU or the like. However, the range of the reference values REF is not limited.

In some embodiments, if the reference value REF is set to one of 0 to 7 and the difference is less than or equal to the reference value REF, the gray-scale value selection circuit 230 outputs the gray-scale value G(n) of the current frame. Otherwise, the gray-scale value selection circuit 230 outputs the compensated gray-scale value G′(n), which will be described in detail below.

The gray-scale value selection circuit 230 includes a frame memory 231, a data storage circuit 233, an operation unit 235, and a selection circuit 237.

The frame memory 231 is configured to store gray-scale values of a frame. When a gray-scale value or gray-scale values of an n^{th} frame (or the current frame) is (are) input to the frame memory 231, the frame memory 231 outputs a gray-scale value or gray-scale values of an (n-1)^{th} frame (or the previous frame) (n is a positive integer).

The data storage circuit 233 is configured to store data regarding a plurality of gray-scale values which are experimentally measured (hereinafter referred to as ‘measured gray-scale values’), to receive the gray-scale values G(n) and G(n-1) of the current and previous frames, and to output data MV regarding at least one of the measured gray-scale values from among the data regarding the measured gray-scale values to the operation unit 235, based on the gay-scale values G(n) and G(n-1).

The data storage circuit 233 includes a look up table (LUT) 234. The LUT 234 is configured to store the measured gray-scale values in the form of a table, based the gray-scale values G(n-1) and G(n) of the previous and current frames. The measured gray-scale values (or data DATA) stored in the LUT 234 may be set by an external register (not shown).

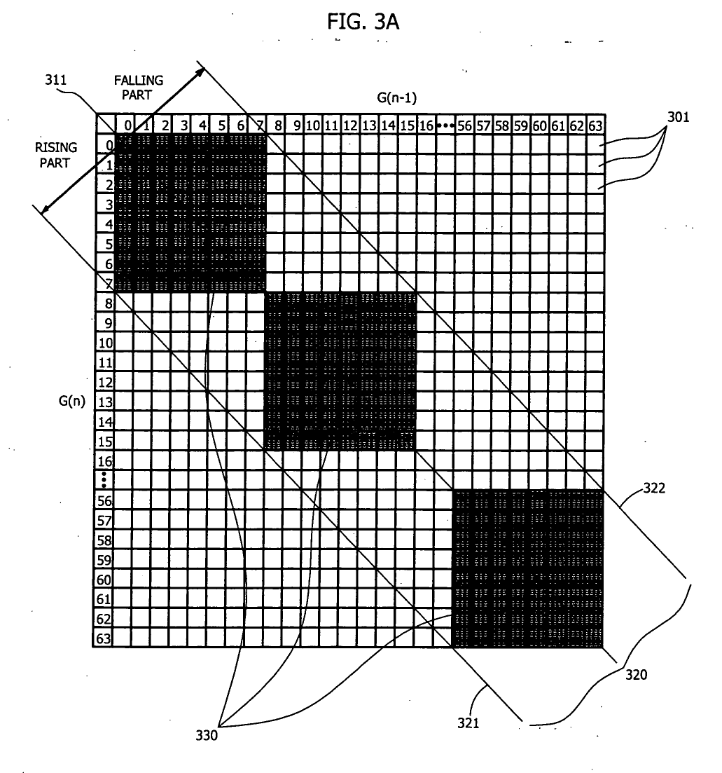

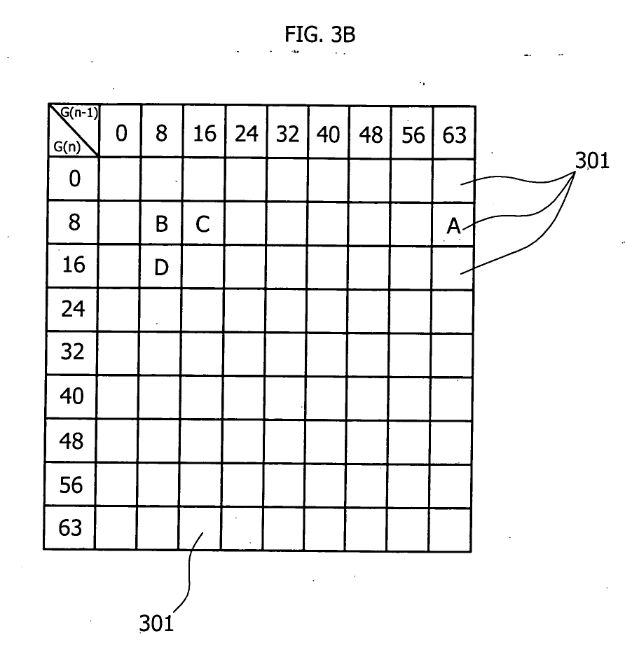

The LUT 234 will now be described in greater detail with reference to FIGS. 3A and 3B.

FIG. 3A illustrates an example of a conventional LUT. Referring to FIG. 3A, the LUT stores all possible gray-scale values of each pixel data when each pixel data is represented with 6 bits (6 bits for each of R, G, B).

Referring to FIG. 3A, the gray-scale value G(n-1) of the previous frame is represented with 6 bits and thus can be expressed with 64 different values, e.g., 0, 1, 2, . . . , 63. Likewise, the gray-scale value G(n) of the current frame can also be expressed with 64 different values, e.g., 0, 1, 2, . . . , 63.

Since the size of the LUT for each of R, G, B is 64×64×6 bits, a total size of the LUT for R, G, B may become 64×64×6×3 bits. Accordingly, when compensated gray-scale values of all of points that the gray-scale values G(n-1) and G(n) of the previous and current frames can have are stored in the LUT, the LUT size may greatly increase.

Referring to FIG. 3B, to reduce the LUT size, compensated gray-scale values of only selected gray-scale values, for example, gray-scale values that have points 0, 8, 16, 24, 32, 40, 48, 56, and 63 are stored in the LUT. That is, in some embodiments, the LUT stores compensated gray-scale values of only 9×9(=81) points, i.e., when {previous frame gray-scale, current frame gray-scale} are {0,0}, {0,8}, {0,16}, . . . , {8,0}, {8,8}, {8,16}, . . . , {63,48}, {63,56}, {63,63}. Therefore, the size of the LUT for each of R, G, B is 9×9×6 bits, and the total size of the LUT can be 9×9×6×3 bits.

When the abbreviated LUT illustrated in FIG. 3B is used, compensated gray-scale values of the other points (or gray-scale values) that are not listed in the LUT may be computed using interpolation by the operation unit 235.

Referring again to FIG. 2, it is assumed that the LUT 234 is constructed similar to the abbreviated LUT illustrated in FIG. 3B. Each cell of the LUT 234 stores a corresponding measured gray-scale value (or data).

The data storage circuit 233 is configured to output the data MV regarding at least one of the measured gray-scale values based on the gray-scale values G(n-1) and G(n) of the previous and current frames.

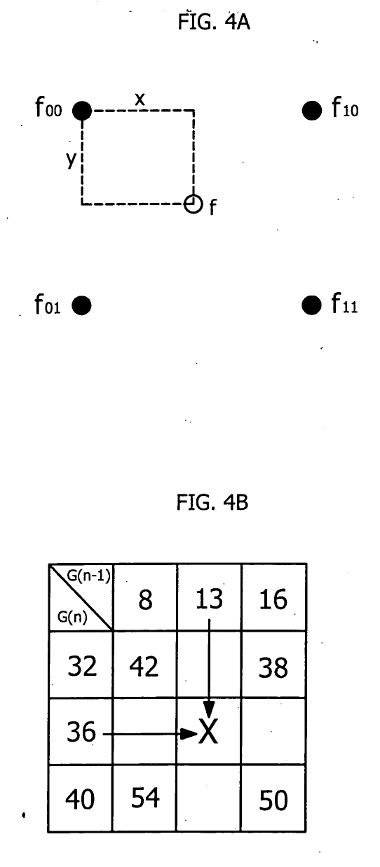

More specifically, when a measured gray-scale value A corresponding to the gray-scale value G(n-1) of the previous frame, e.g., 63 of FIG. 3B, and the gray-scale value G(n) of the current frame, e.g., 8 of FIG. 3B, is present in a corresponding cell 301 of the LUT, the data storage circuit 233 outputs the measured gray-scale value A. However, a measured gray-scale value corresponding to the gray-scale value G(n-1), e.g., 10 of FIG. 3B, and the gray-scale value G(n), e.g., 10 of FIG. 3B, is not present in the cell 301. In this case, the data storage circuit 233 outputs a reference gray-scale value B of a point adjacent to the gray-scale value G(n-1)=10 and the gray-scale value G(n)=10, and two neighbor gray-scale values C and D adjacent to the reference gray-scale value B (which will later be described in greater detail with reference to FIGS. 4A and 4B).

The operation unit 235 is configured to perform an operation on the data MV regarding at least one of the plurality of the measured gray-scale values, which is received from the data storage circuit 233, and to output the compensated gray-scale value G′(n) according to the operation result.

FIG. 4A is a conceptual diagram illustrating computation of a compensated gray-scale value that is not listed in an LUT, according to some embodiments of the present invention. Referring to FIG. 4A, f₀₀, f₁₀, f₀₁, and f₁₁ denote measured gray-scale values stored in the LUT 234 of FIG. 2, and f denotes a compensated gray-scale value to be obtained by performing a predetermined operation.

The compensated gray-scale value f may be given by:
f=f₀₀+ax−by+cxy
a=f₁₀−f₀₀ (2)
b=f₀₁−f₀₀
c=f₀₀+f₁₁−f₀₁−f₁₀
where fan may be omitted, that is, the fourth item cxy may need not be considered in computing the compensated gray-scale f.

FIG. 4B is a detailed table illustrating computation of a compensated gray-scale value that is not included in an LUT according to some embodiments of the present invention. Referring to FIG. 4B, when the gray-scale value G(n-1) of the previous frame is 13 and the gray-scale value G(n) of the current frame is 36, i.e., a point of {13, 36}, a compensated (measured) gray-scale value corresponding to the point of {13, 36} is not stored in the LUT.

Thus, the data storage circuit 233 outputs a measured gray-scale value 42 corresponding to a point of {8, 32} adjacent to the point of {13, 36} as a reference gray-scale value to the operation unit 235.

Also, the data storage circuit 233 outputs measured gray-scale values 38 and 54 that respectively correspond to two neighbor points of {16, 32} and {8, 40} adjacent to the point of {8, 32}, corresponding to the reference gray-scale value 42, to the operation unit 235. In this case, the data storage circuit 233 outputs three measured gray-scale values (or data) 42, 38, and 54 to the operation unit 235.

As described above, to obtain a compensated gray-scale value not listed in the LUT by performing an operation, measured gray-scale values of three points are used. To simultaneously output the measured gray-scale values of the three points from the LUT, the LUT may have a bus line structure that provides concurrent accessing of three cells of the LUT. Assuming that each measured gray-scale value is represented with 6 bits, 6×3(=18) bit lines may be used to access the LUT. For R, G, B, 6×3×3(=54) bit lines may be used to access the LUT.

The operation unit 235 receives data 42, 38, and 54, and is configured to perform interpolation thereon using the following Equation (3) to obtain a compensated gray-scale value G′(n), and outputs the compensated gray-scale value G′(n) to the selection circuit 237.

$${G}^{′} ( n ) = X = f + a \times \frac{( 36 - 32 )}{8} - b \times \frac{( 13 - 8 )}{8} \qquad ( 3 )$$

Referring again to FIG. 4B, the greater the gray-scale value G(n) of the current frame, the greater the compensated gray-scale value thereof, but the greater the gray-scale value G(n-1) of the previous frame, the less the compensated gray-scale value thereof. In Equation (3), f is 42, the difference (a) between measured gray-scale values is 12(=54−42), and the difference (b) between measured gray-scale values is 4(=42−38). It will be understood that Equation (3) is just an example of an operation that the operation unit 235 can perform, according to some embodiments of the present invention.

The operation unit 235 is configured to output the compensated gray-scale value G′(n) obtained through interpolation to the selection circuit 237.

The selection circuit 237 is configured to receive the compensated gray-scale value G′(n) from the operation unit 235, and the gray-scale value G(n) of the current frame, and to output the compensated gray-scale value G′(n) or the gray-scale value G(n) in response to the selection signal SEL. The selection circuit 237 may be a multiplexer.

The selection signal generation circuit 210 is configured to determine whether the compensated gray-scale value G′(n) obtained through interpolation or the gray-scale value G(n) of the current frame that is not compensated for will be output, and to output the selection signal SEL indicating the determination result to the selection circuit 237.

The register 211 of the selection signal generation circuit 210 is configured to store the reference value REF that allows a particular region of the LUT not to be selectively compensated for.

Referring again to FIG. 3A, compensation for a gray-scale value in a particular region of the LUT may lead to image degradation. The particular region may be located around a diagonal line 311 of the LUT. In FIG. 3A, the gray-scale values G(n-1) of the previous frame are greater than the gray-scale values G(n) of the current frame in an upper region of the LUT with respect to the diagonal line 311. That is, the upper region is a falling part in which the gray-scale values G(n) of the current frame are less than the gray-scale values G(n-1) of the previous frame.

Also, the gray-scale values G(n-1) of the previous frame are less than the gray-scale values G(n) of the current frame in a lower region of the LUT with respect to the diagonal line 311. That is, the lower region is a rising part in which the gray-scale values G(n) of the current frame are greater than the gray-scale values G(n-1) of the previous frame. As well known, liquid crystal material may have very different response speeds in the rising and falling parts thereof. According to some embodiments of the invention, a border region between the rising and falling parts is not selectively compensated for in order to allow image quality to be maintained.

In order for a predetermined region of the LUT not to be compensated for, the selection circuit 210 of FIG. 2 generates the selection signal SEL according to a predetermined rule, e.g., using Equation (1). When the selection circuit 210 generates the selection signal SEL using Equation (1) and the reference value REF is 7, the predetermined region that need not be compensated for can correspond to a region 320 between lines 321 and 322, illustrated in FIG. 3A. However, the predetermined rule used to select a region not to be compensated for is not limited. For instance, the predetermined rule may be set such that block regions 330 around the diagonal line 311 of FIG. 3A are not compensated for.

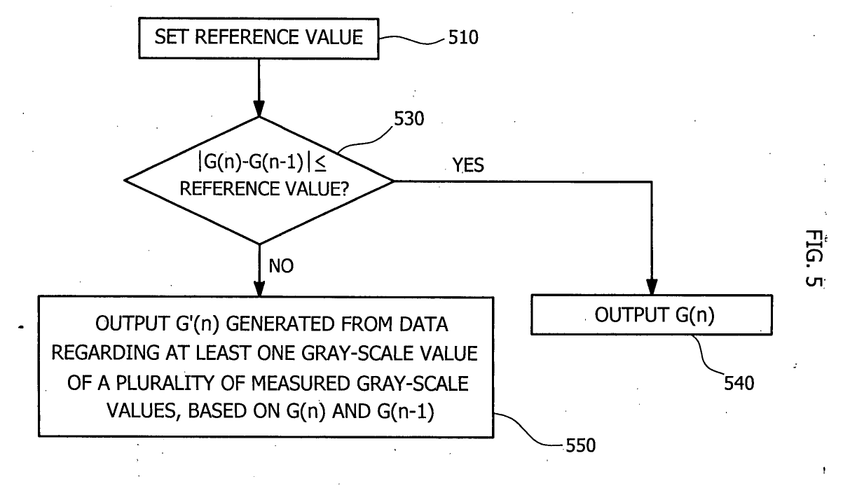

FIG. 5 is a flowchart illustrating operations for compensating for gray-scale values according to some embodiments of the present invention. Compensating for gray-scale values according to some embodiments of the present invention will now be described with reference to FIGS. 2 and 5.

First, a reference value REF is set in the register 211 using a CPU (Block 510). The reference value REF may be set to one of 0 to 7. The reference value REF is used to output a gray-scale value G(n) of a current frame to the data driver 130 when the difference between the gray-scale value G(n) of the current frame and the gray-scale value G(n-1) of a previous frame has a predetermined value.

The selection signal generation circuit 210 compares the difference between the gray-scale value G(n) of the current frame and the gray-scale value G(n-1) of the previous frame with the reference value REF (Block 530).

If the difference is less than or equal to the reference value REF, the gray-scale value selection circuit 230 outputs the gray-scale value G(n) of the current frame that is not compensated for, in response to a selection signal SEL (Block 540).

However, if the difference is greater than the reference value REF, the gray-scale value selection circuit 230 outputs a compensated gray-scale value G′(n) in response to the selection signal SEL (Block 550).

The compensated gray-scale value G′(n) is generated by the operation unit 235 based on data regarding at least one of a plurality of measured gray-scale values, with data regarding the measured gray-scale values being stored in the data storage circuit 233.

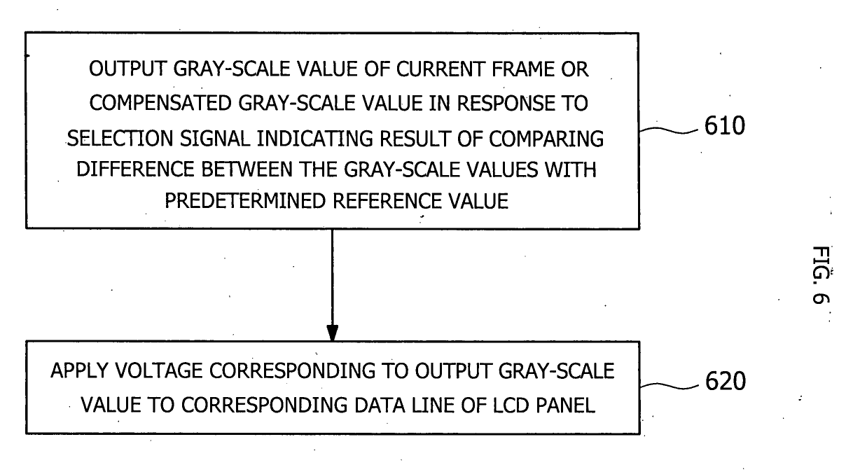

FIG. 6 is a flowchart illustrating driving data lines of a display device according to some embodiments of the present invention. Driving data lines of a display device that includes an LCD panel 110 with a plurality of pixels 111, a respective one of which is located at an intersection of a respective one of the data lines and a corresponding gate line, according to some embodiments of the present invention, will now be described with reference to FIGS. 1 and 6.

First, the gray-scale value compensation circuit 200 receives a gray-scale value G(n) of a current frame and a gray-scale (G(n-1) of a previous frame, computes the difference between them, and outputs the gray-scale value G(n) or a compensated gray-scale value G′(n) to the data driver 130 in response to a selection signal SEL indicating a result of comparing the difference with a predetermined reference value REF (Block 610).

Next, the data driver 130 applies a voltage corresponding to the gray-scale value G(n) or the compensated gray-scale value G′(n) received from the gray-scale value compensation circuit 200 to a corresponding data line of the LCD panel 110, thereby increasing the response speed of the LCD panel 110 (620). The term “gray-scale value” used in this disclosure may also be referred to as “gray signal” or “gray voltage”.

As described above, in methods and circuits for compensating for gray-scale values according some embodiments to the present invention, only measured gray-scale values of only selected points are stored in an LUT and the other gray-scale values are obtained by performing an operation, which can reduce the size of the LUT. Therefore, some embodiments of the present invention may be used in mobile small and medium sized display devices.

Further, according to some embodiments of the present invention, it is possible to selectively prevent a predetermined region of the LUT from being compensated for, the predetermined region being located around a diagonal line of the LUT or including the diagonal line, thereby allowing image quality to be maintained in a particular region of the LUT.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method of compensating for gray-scale values of a display comprising:
selectively providing a gray-scale value of a current frame of the display or a compensated gray-scale value of the current frame of the display in response to a difference between the gray-scale value of the current frame of the display and a gray-scale value of a preceding frame of the display relative to a reference value.

2. The method of claim 1 wherein selectively providing comprises:
providing the compensated gray-scale value of the current frame if the difference between the gray-scale value of the current frame and the gray-scale value of the preceding frame exceeds the reference value; and
providing the gray-scale value of the current frame if the difference between the gray-scale value of the current frame and the gray-scale value of the preceding frame is less than the reference value.

3. The method of claim 2 further comprising:
determining the compensated gray-scale value by interpolating values in a look-up table.

4. The method of claim 1 further comprising:
applying to the display for the current frame, the gray-scale value or the compensated gray-scale value that is selectively provided.

5. The method of claim 1 wherein the display is a liquid crystal display.

6. A circuit that is configured to compensate for gray-scale values of a display by performing the method of claim 1.

7. A circuit that is configured to compensate for gray-scale values of a display by performing the method of claim 2.

8. A liquid crystal display comprising a circuit that is configured to compensate for gray-scale values by performing the method of claim 1.

9. A liquid crystal display comprising a circuit that is configured to compensate for gray-scale values by performing the method of claim 2.

10. A method of compensating for gray-scale values of a liquid crystal display, comprising:
setting a reference value;
comparing a difference between a gray-scale value of a current frame and a gray-scale value of a previous frame with the reference value; and
outputting the gray-scale value of the current frame or a compensated gray-scale value according to the comparison result.

11. The method of claim 10, wherein the compensated gray-scale value is generated based on data regarding at least one of a plurality of measured gray-scale values, where data regarding the measured gray-scale values is stored in a data storage circuit.

12. The method of claim 10, wherein during the setting of the reference value, the reference value is set to one of 0 to 7.

13. The method of claim 10, wherein the outputting of the gray-scale value of the current frame or the compensated gray-scale value comprises:
outputting the compensated gray-scale value when the difference is greater than the reference value, and outputting the gray-scale value of the current frame otherwise.

14. A circuit for compensating for gray-scale values, comprising:
a selection signal generation circuit configured to receive a gray-scale value of a current frame and a gray-scale value of a previous frame, to compute a difference between the received gray-scale values, and to generate a selection signal indicating a result of comparing the difference with a reference value; and
a gray-scale value selection circuit configured to output the gray-scale value of the current frame or a compensated gray-scale value in response to the selection signal.

15. The circuit of claim 14, wherein the selection signal generation circuit comprises:
a register configured to store the reference value;
an operation unit configured to receive the gray-scale values of the current and previous frames, to compute the difference between the received gray-scale values, and to output the computed difference; and
a comparator configured to receive the reference value from the register and the difference from the operation unit, to compare the reference value with the difference, and to output the selection signal indicating the comparison result.

16. The circuit of claim 14, wherein the gray-scale value selection circuit comprises:
a data storage circuit configured to store data regarding a plurality of measured gray-scale values, to receive the gray-scale values of the current and previous frames, and to output the data regarding at least one of the measured gray-scale values based on the gray-scale values of the current and previous frames;
an operation unit configured to perform an operation on the data regarding the at least one gray-scale value output from the data storage circuit, and to output the compensated gray-scale value according to the operation result; and
a selection circuit configured to receive the compensated gray-scale value from the operation unit and the gray-scale value of the current frame, and to output the gray-scale value of the current frame or the compensated gray-scale value in response to the selection signal.

17. The circuit of claim 16, wherein the data storage circuit comprises a bus line structure that provides concurrent accessing of the data regarding at least three measured gray-scale values.

18. A display device comprising:
a liquid crystal display panel comprising a plurality of pixels, a respective one of which is located at a respective intersection of a gate line and a corresponding data line;
a gray-scale value compensation circuit configured to receive a gray-scale value of a current frame and a gray-scale value of a previous frame, to compute a difference between the received gray-scale values and to output the gray-scale value of the current frame or a compensated gray-scale value in response to a selection signal indicating a result of comparing the difference with a reference value;
a data driver configured to apply a voltage corresponding to the gray-scale value of the current frame or the compensated gray-scale value, which are received from the gray-scale value compensation circuit, to a corresponding data line of the liquid crystal display panel; and
a gate driver configured to apply a gate-on signal to a corresponding gate line of the liquid crystal display panel.

19. The display device of claim 18, wherein the gray-scale value compensation circuit comprises:
a selection signal generation circuit configured to receive the gray-scale values of the current and previous frames, to compute the difference between the received gray-scale values, and to generate the selection signal indicating the result of comparing the difference with the reference value; and
a gray-scale value selection circuit configured to output the gray-scale value of the current frame or the compensated gray-scale value in response to the selection signal.

20. The display device of claim 19, wherein the selection signal generation circuit comprises:
a register configured to store the reference value;
an operation unit configured to receive the gray-scale values of the current and previous frames, to compute the difference between the received gray-scale values, and to output the computed difference; and
a comparator configured to receive the reference value from the register and the difference from the operation unit, to compare them, and to generate the selection signal indicating the comparison result.

21. The display device of claim 19, wherein the gray-scale value selection circuit comprises:
a data storage circuit configured to store data regarding a plurality of measured gray-scale values, to receive the gray-scale values of the current and previous frames, and to output the data regarding at least one of the measured gray-scale values based on the gray-scale values of the current and previous frames;
an operation unit configured to perform an operation on the data regarding the at least one gray-scale value received from the data storage circuit, and to output the compensated gray-scale value according to the operation result; and
a selection circuit configured to receive the compensated gray-scale value from the operation unit and the gray-scale value of the current frame, and to output the gray-scale value of the current frame or the compensated gray-scale value in response to the selection signal.

22. The display device of claim 21, wherein the data storage circuit comprises a bus line structure that provides concurrent accessing of the data regarding at least three measured gray-scale values.

23. A method of driving data lines of a display device which includes a liquid crystal display panel comprising a plurality of pixels, a respective one of which is located at a respective intersection of a gate line and a corresponding data line, the method comprising:
(a) receiving a gray-scale value of a current frame and a gray-scale value of a previous frame, computing a difference between the received gray-scale values, and outputting the gray-scale value of the current frame or a compensated gray-scale value according to a result of comparing the difference with a reference value; and
(b) applying a voltage corresponding to the gray-scale value of the current frame or the compensated gray-scale value output in (a) to a corresponding data line of the liquid crystal display panel.

24. The method of claim 23, wherein (a) comprises:
receiving the gray-scale values of the current and previous frames; and
performing an operation on data regarding at least one of a plurality of measured gray-scale values based on the gray-scale values of the current and previous frames, and generating the compensated gray-scale value corresponding to the operation result.

25. A method of compensating for gray-scale values, comprising:
receiving a gray-scale value of a current frame and a gray-scale value of a previous frame;
generating a selection signal based on the gray-scale values of the current and previous frames and a reference value; and
outputting the gray-scale value of the current frame or a compensated gray-scale value in response to the selection signal,
wherein the reference value is set to determine a subset of gray voltages which is not to be compensated for.

26. A circuit for compensating for a gray-scale of a liquid crystal display, comprising;
a selection signal generation circuit configured to receive a gray-scale value of a current frame and a gray-scale value of a previous frame, and to generate a selection signal from the received gray-scale values and a reference value; and
a gray-scale value selection circuit configured to output the gray-scale value of the current frame or a compensated gray-scale value in response to the selection signal,
wherein the reference value is set to determine a subset of gray voltages which is not to be compensated for.
